(19) United States
(12) Patent Application Publication
(10) Pub. No.: US 2014/0379822 A1
(43) Pub. Date: Dec. 25, 2014

(54) AUTOMATIC APPOINTMENT OFFER AND CREATION BETWEEN PARTIES

(71) Applicant: TimeTrade Systems, Inc., Tewksbury, MA (US)

(72) Inventor: Gary S. Ambrosino, Dover, MA (US)

(73) Assignee: TimeTrade Systems, Inc., Tewksbury, MA (US)

(21) Appl. No.: 14/261,727

(22) Filed: Apr. 25, 2014

Related U.S. Application Data
(60) Provisional application No. 61/837,679, filed on Jun. 21, 2013.

(51) Int. Cl. H04L 12/58; H04L 29/08

(52) U.S. Cl. CPC H04L 51/04; H04L 67/18
USPC 709/206

(57) ABSTRACT

A method of suggesting meetings between users is provided. A server receives from a plurality of user devices, data indicating geographic location on future dates of a plurality of users, calendar information of the plurality of users and interests of the plurality of users. The data is analyzed to determine whether data for at least two users match. If it is determined that data matches for at least two users, an appointment offer is sent for a meeting during a period of time when the at least two users are available. Acceptance or rejection of the appointment offer is received from each of the at least two users. If the at least two users accept the appointment offer, a meeting invitation is sent to each of the at least two users in order to insert the meeting into a calendar application for the at least two users.

### CROSS REFERENCE TO RELATED APPLICATION

This application claims priority to U.S. Provisional Application No. 61/837,679, filed Jun. 21, 2013, the entirety of which is incorporated herein by reference.

### TECHNICAL FIELD

The present disclosure relates to web-based calendar/appointment systems.

### BACKGROUND

Meeting/appointment scheduling between individuals can be cumbersome. Often individuals do not have the time to determine whether another person may be located in the same geographical area on a particular day, with whom which a meeting would be useful. This would require constant reviewing of email and other data about the availability and location of other individuals, in both a personal and business context.

### SUMMARY

Briefly, in accordance with one embodiment, a method of suggesting meetings between users is provided. A server receives from a plurality of user devices, data indicating geographic location on future dates of a plurality of users, calendar information of the plurality of users and interests of the plurality of users. The data is analyzed to determine whether data for at least two users match. If it is determined that data matches for at least two users, an appointment offer is sent for a meeting during a period of time when the at least two users are available. Acceptance or rejection of the appointment offer is received from each of the at least two users. If the at least two users accept the appointment offer, a meeting invitation is sent to each of the at least two users in order to insert the meeting into a calendar application for the at least two users.

In accordance with another embodiment, a method is provided in which, at a user device of a first user, an appointment offer is received for a meeting with a second user during a period of time at a future date when the first user and second user are available and will be within a predetermined distance of each other at a future date and it has been determined that the first user and the second user share a mutual interest for a meeting. Acceptance or rejection of the appointment offer is sent from the user device of the first user. A meeting invitation is received at the user device of the first user if the first user and second user have accepted the appointment offer.

### BRIEF DESCRIPTION OF THE DRAWINGS

FIG. 1 is a block diagram of a system configured to automatically generate appointment offers, according to an example embodiment.

FIG. 2 is a diagram depicting the automatic provisioning/pushing of user location/availability/goal data to a matching system, according to an example embodiment.

FIG. 3 is a diagram depicting the determining of no match of user location/availability/goal data for two users, according to an example embodiment.

FIG. 4 is a diagram depicting the determining of a match of user location/availability/goal data for two users and sending of appointment offers to the two users, according to an example embodiment.

FIG. 5 is a diagram depicting the acceptance of appointment offers by the two users and the sending of appointments to the two users, according to an example embodiment.

FIG. 6 is a flow generally depicting the matching and appointment process according to an example embodiment.

FIG. 7 is a block diagram of a server configured to perform the techniques described herein.

### DETAILED DESCRIPTION OF EXAMPLE EMBODIMENTS

The invention presented herein pertains to a system that automatically creates appointment offers between a user and others in their social network based on their current location, willingness to meet with people from different degrees of their social graph, type of transaction they wish to meet to discuss, and their regular calendar availability.

For example, a sales representative for a company that sells computers attending a trade conference would automatically be prompted by the system with appointment offers to meet with people at the same conference who are interested in purchasing the type of goods that they sell. Should both users agree to the meeting, the time will be chosen automatically by the system (based on the availability of the users) and an appointment automatically added to both of their calendars.

This invention represents a novel approach to time management between multiple parties who are connected to each other within an existing social network. As in most social networks, connections might be strong (the parties are friends of each other) or weak (in the case of a “friend of a friend”).

Through the participation of mobile user devices belonging to each user of the system, the system is made aware of several pieces of information:

The inventory of published availability for each user in the system.

Their connections within a social networking graph.

The current location of each participating user through existing means (GPS, etc.).

The radius (predetermined distance) within which the user wishes to allow the system to look for automatic appointment matches.

The type of meeting the user wishes to have (for example: buying products, selling services, recruitment, gaining employment, etc.). This is referred to as the goals or interest of a user.

The social graph tolerance for automatic meeting offers (for example, some users may only wish to have the system offer appointments all throughout the day with 1st degree connections from their social graph, whereas they might only want to open up the late afternoon for people who are 2nd- or 3rd-degree and beyond).

As the locations of individual users change, the system evaluates all other participating users in the same location for potential matches in criteria. If a match is found that meets the configured criteria of both users, the system notifies both users of the offer to automatically create a meeting between them. Once both agree, the system then creates the appointment for both of them.

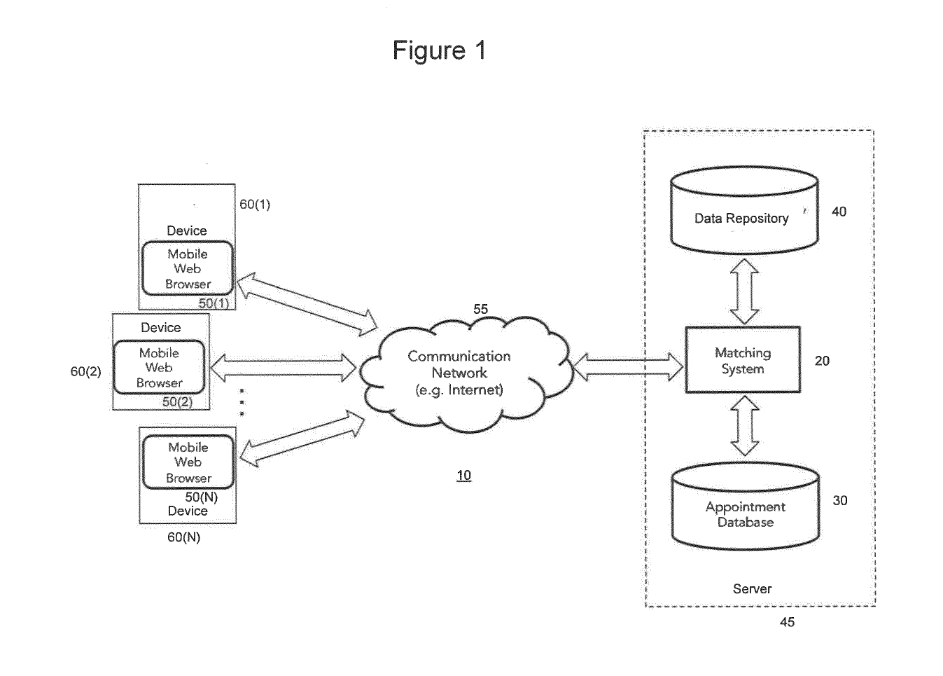

Referring first to FIG. 1 shows the arrangement of a system for the automatic provisioning of user's location, calendar and goal data to the repository over the Internet. The system, shown generally at reference numeral 10, includes a matching system component 20, an appointment database 30 and a data repository 40 that stores location, availability and goal data. As described hereinafter, the matching system component 20, appointment data 30 and data repository 40 may be managed/run by one or more applications on a server 45. The matching system 20 communicates with mobile web browsers 50(1)-50(N) by way of a communication network, e.g., the Internet, shown at reference numeral 55. A different user is associated with each of the mobile web browsers 50(1)-50(N). Moreover, the mobile web browsers 50(1)-50(N) are running within user devices 60(1)-60(N), respectively.

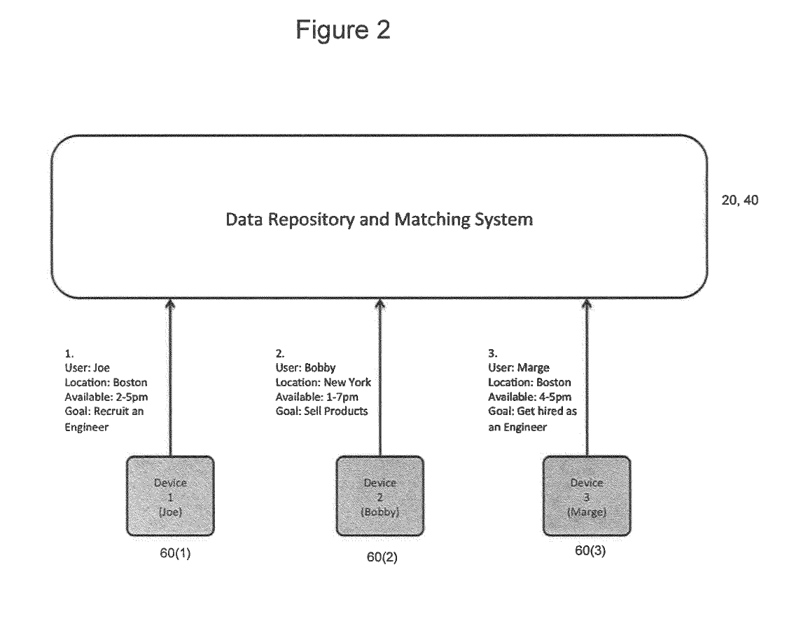

Reference is now made to FIG. 2. FIG. 2 shows how user data is automatically provisioned into the matching system 20 and data repository 40. The user data includes a user's location, calendar and goal data. For example, for the user “Joe” associated with device 60(1), data is provisioned indicating that he is in Boston and is available from 2-5 pm on a particular day. The goal of his availability is to indicate that he is interested in recruiting an engineer. For the user “Bobby” associated with device 60(2), data is provisioned to indicate that he is in New York, is available from 1-7 PM on the particular day, and he is interested in selling products. For the user “Marge” associated with device 60(3), data is provided indicating that she is in Boston on the particular day, is available from 4-5 pm, and is interested in getting hired as an engineer.

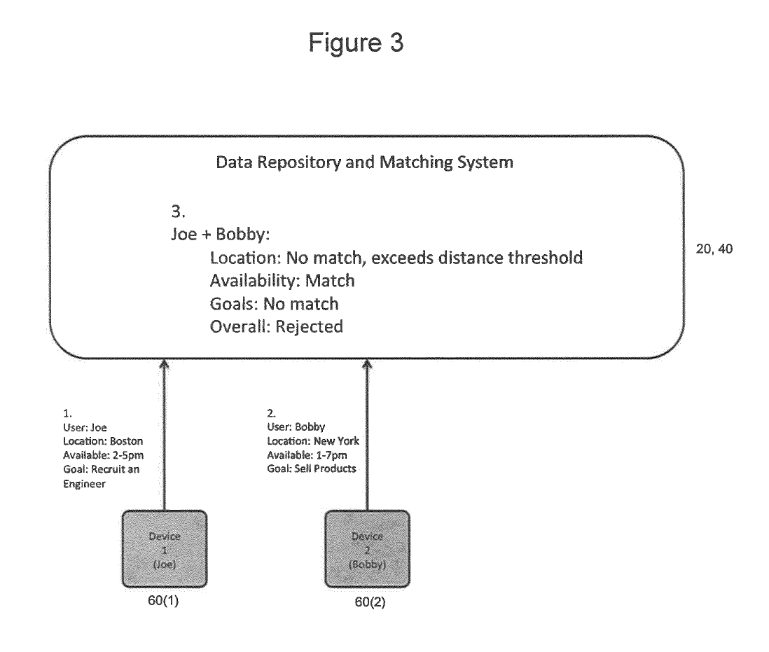

Reference is now made to FIG. 3. FIG. 3 shows the rejection of a match between two users because they are (a) too far from each other to make an appointment viable and (b) do not share matching goals for a meeting. In this example, users Joe and Bobby are in two different cities on the particular day. Thus, the location criterion does not match. Their time availability does match, but their “goals” or interest criterion does not match. Therefore, there is no overall match between Joe and Bobby on this particular day for their provisioned goals or interests.

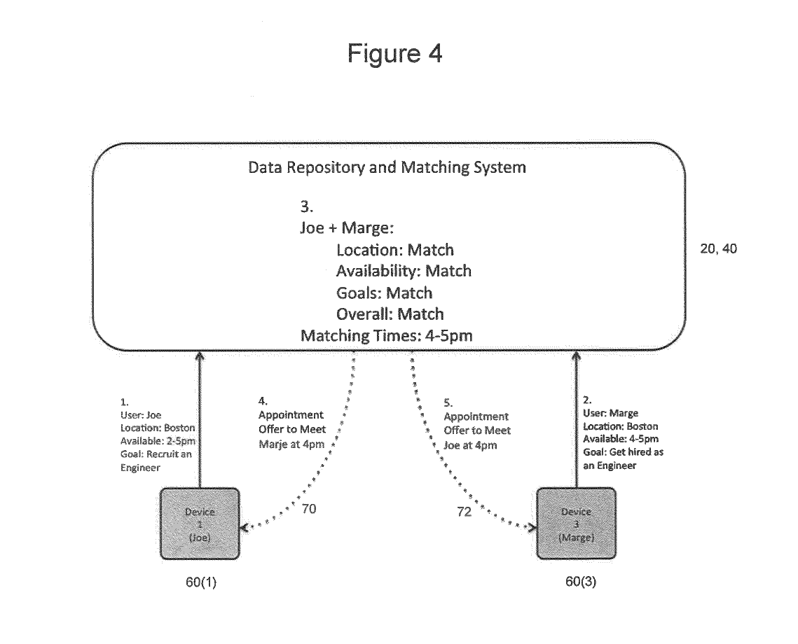

FIG. 4 shows how the system discovers a match between two users who are in the same location, have overlapping available times, and have matching appointment goals, leading to an appointment offer being automatically made to both of them. Specifically, Joe and Marge are both in Boston on the particular day and there is overlap (at least partially) between their availability times. Moreover, Joe's goal is to hire an engineer and Marge's goal is to get hired as an engineer. Therefore, their goals/interests match. Therefore, the matching system 20 sends to Joe's device 60(1) a message 70 that includes information offering an appointment to meet with Marge at 4 pm. Similarly, the matching system 20 sends to Marge's device 60(3) a message that includes information offering an appointment to meet with Joe at 4 PM.

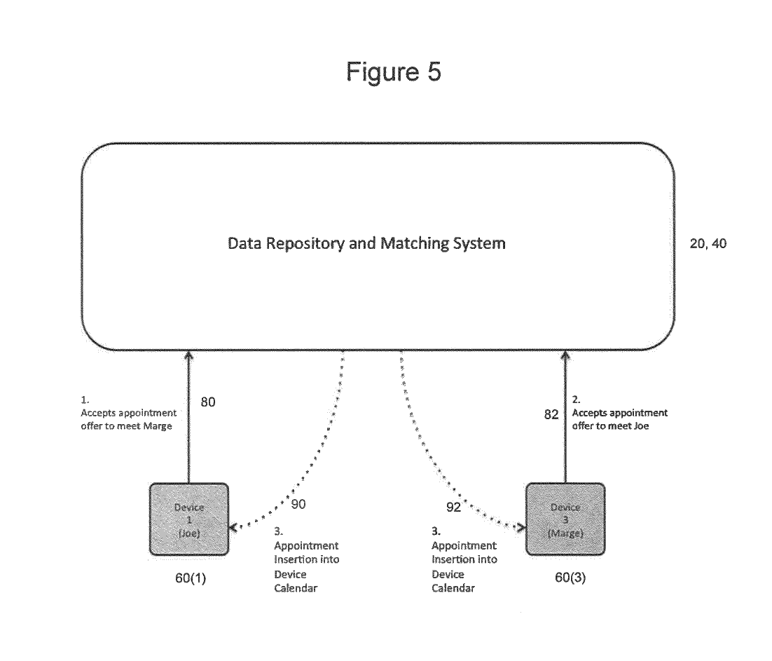

Reference is now made to FIG. 5. FIG. 5 shows what occurs when two users accept an automatic appointment offer. When Joe accepts the offer for the appointment with Marge, his device sends to the matching system 20 a message 80 that includes information accepting the appointment offer to meet with Marge. Likewise, when Marge accepts the offer for the appointment with Joe, her device sends to the matching system 20 a message 82 that includes information accepting the appointment offer to meet with Joe. Then, the matching system 20 sends to Joe's device 60(1), at 90, a message that includes information to insert the appointment into Joe's calendar running on his device 60(1). The matching system 20 also sends to Marge's device 60(3), at 92, a message that includes information to insert the appointment into Marge's calendar running on her device 60(3).

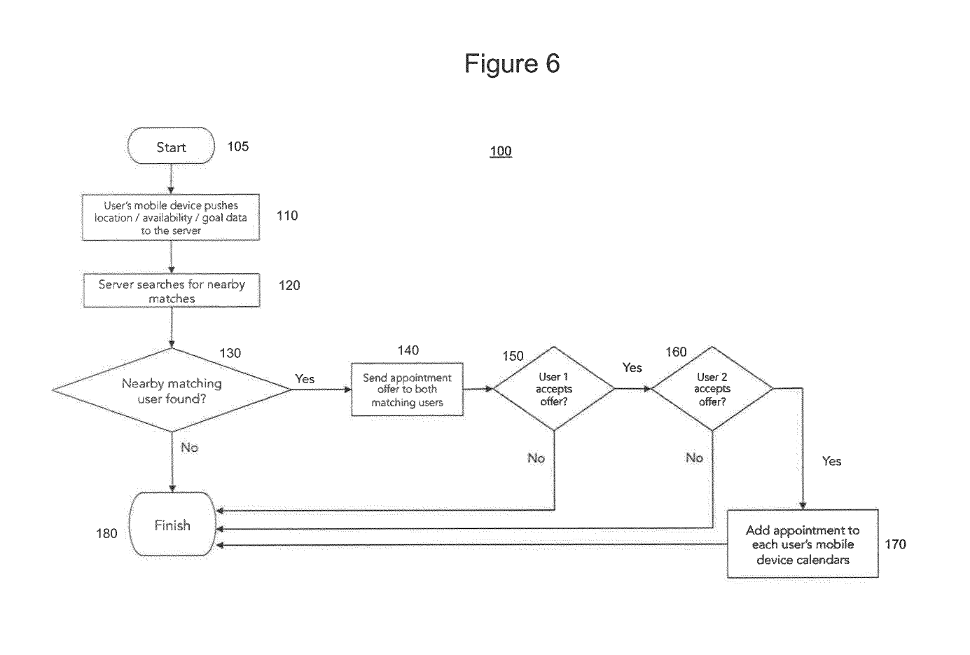

FIG. 6 shows a flow chart 100 depicting operations performed by the matching system component 20 for the techniques presented herein. The operations begin at 105, and at 110, the server on which matching system component 20 is running receives from user devices the location/availability/goal data. This data may be pushed to the server from user devices as user's enter such data into their devices or update such information in the social network application. At 120, the matching system component on the server searches for matches across the location/availability/goal data. The server may perform operation 120 on a periodic basis, such as every day, e.g., every evening. At 130, if the server determines that it has found a match, then at 140, it sends appointment offers to the matching users (could be two or more users). At 150 and 160, if both users accept the appointment offers, then at 170, the server adds the appointment to the calendar for each of the users. If at least one of the users declines/rejects the appointment offer, the process ends at 180. Also, if no matches are found at 130, then the process ends at 180.

To summarize, a method of suggesting meetings between users is provided. A server receives from a plurality of user devices, data indicating geographic location on future dates of a plurality of users, calendar information of the plurality of users and interests of the plurality of users. The data may include data for the plurality of user devices for users that are members of a social network. Moreover, information may be received from users that indicates time of day preference based on social distance in the social network, as well as preference information indicating a predetermined distance within which a user allows for determination of appointment matches. The data is analyzed to determine whether data for at least two users match. If it is determined that data matches for at least two users, an appointment offer is sent for a meeting during a period of time when the at least two users are available. The data may be analyzed to determine whether at least two users have mutual interests and will be located within a predetermined distance on a particular day. The data may be analyzed to determine whether there is a match based further on social distance in the social network between users.

Acceptance or rejection of the appointment offer is received from each of the at least two users. If the at least two users accept the appointment offer, a meeting invitation is sent to each of the at least two users in order to insert the meeting into a calendar application for the at least two users.

Furthermore, from the perspective of a user device of an arbitrary first user, a method is provided in which, an appointment offer is received for a meeting with a second user during a period of time at a future date when the first user and second user are available and will be within a predetermined distance of each other at a future date and it has been determined that the first user and the second user share a mutual interest for a meeting. Acceptance or rejection of the appointment offer is sent from the user device of the first user. A meeting invitation at the user device of the first user is received if the first user and second user have accepted the appointment offer. Information may also be sent from the user device of the first user, the information indicating the predetermined distance for use in determining whether to suggest a meeting between the first user and another user. Information also be sent from the first user device that indicates a time of day preference based on social distance in a social network of which the first user is a member.

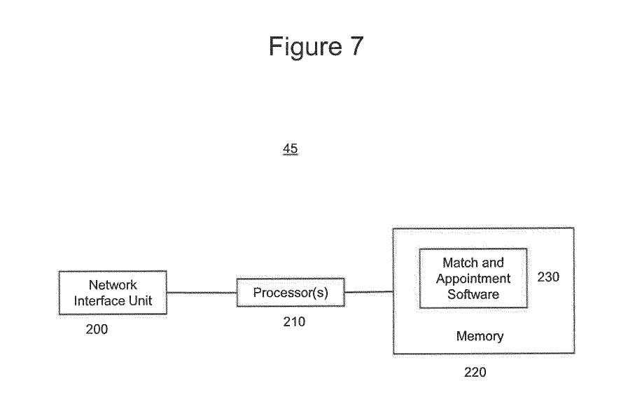

Turning to FIG. 7, an example block diagram is shown for server 45 on which the matching system component 20 and other functions may be running The server 45 includes a network interface unit 200 configured to enable network communications to send messages to and receive messages from user devices. One or more processors 210 are provided that execute software stored in memory 220. The processor(s) 210 is, for example, a microprocessor or microcontroller. To this end, the memory 220 stores instructions for match and appointment software 230. When the one or more processors 210 execute the match and appointment software 230, the server 45 performs the operations described herein in connection with FIGS. 1-6.

Memory 220 may comprise read only memory (ROM), random access memory (RAM), magnetic disk storage media devices, optical storage media devices, flash memory devices, electrical, optical, or other physical/tangible memory storage devices. Thus, in general, the memory 220 may comprise one or more tangible (non-transitory) computer readable storage media (e.g., a memory device) encoded with software comprising computer executable instructions and when the software is executed (by the processor(s) 210) it is operable to perform the operations described herein.

In apparatus form, an apparatus (e.g., a server or virtualized process running in a data center) is provided including a network interface unit configured to enable communications over a network, and at least one processor coupled to the network interface unit. The processor is configured to: obtain data indicating geographic location on future dates of a plurality of users, calendar information of the plurality of users and interests of the plurality of users; analyze the data to determine whether data for at least two users match; if it is determined that data matches for at least two users, cause an appointment offer to be sent for a meeting during a period of time when the at least two users are available; receive acceptance or rejection of the appointment offer from each of the at least two users; and if the at least two users accept the appointment offer, cause a meeting invitation to be sent to each of the at least two users in order to insert the meeting into a calendar application for the at least two users.

The above description is intended by way of example only.

What is claimed is:

1. A computer-implemented method comprising:
obtaining data indicating geographic location on future dates of a plurality of users, calendar information of the plurality of users and interests of the plurality of users;
analyzing the data to determine whether data for at least two users match;
if it is determined that data matches for at least two users, sending an appointment offer for a meeting during a period of time when the at least two users are available;
receiving acceptance or rejection of the appointment offer from each of the at least two users; and
if the at least two users accept the appointment offer, sending a meeting invitation to each of the at least two users in order to insert the meeting into a calendar application for the at least two users.

2. The method of claim 1, wherein analyzing comprises analyzing the data to determine whether at least two users have mutual interests and will be located within a predetermined distance on a particular day.

3. The method of claim 1, wherein obtaining data comprises obtaining data for the plurality of users devices for users that are members of a social network.

4. The method of claim 3, wherein analyzing comprises determining whether there is a match based further on social distance in the social network between users.

5. The method of claim 3, wherein obtaining comprises receiving from users information indicating time of day preference based on social distance in the social network.

6. The method of claim 1, wherein receiving comprises receiving from users information indicating a predetermined distance within which a user allows for determination of appointment matches.

7. An apparatus comprising:
a network interface unit configured to enable communications over a network;
at least one processor coupled to the network interface unit and configured to:
obtain data indicating geographic location on future dates of a plurality of users, calendar information of the plurality of users and interests of the plurality of users;
analyze the data to determine whether data for at least two users match;
if it is determined that data matches for at least two users, cause an appointment offer to be sent for a meeting during a period of time when the at least two users are available;
receive acceptance or rejection of the appointment offer from each of the at least two users; and
if the at least two users accept the appointment offer, cause a meeting invitation to be sent to each of the at least two users in order to insert the meeting into a calendar application for the at least two users.

8. The apparatus of claim 7, wherein the processor is configured to analyze the data to determine whether the at least two users have mutual interests and will be located within a predetermined distance on a particular day.

9. The apparatus of claim 7, wherein the processor is configured to obtain data for the plurality of users devices for users that are members of a social network.

10. The apparatus of claim 9, wherein the processor is configured to determine whether there is a match based further on social distance in the social network between users.

11. The apparatus of claim 9, wherein the processor is configured to receive from users information indicating time of day preference based on social distance in the social network.

12. The apparatus of claim 7, wherein the processor is configured to analyze based on information obtained from a user that indicates a predetermined distance within which a user allows for determination of appointment matches.

13. A method comprising:
at a user device of a first user, receiving an appointment offer for a meeting with a second user during a period of time at a future date when the first user and second user are available and will be within a predetermined distance of each other at a future date and it has been determined that the first user and the second user share a mutual interest for a meeting;
sending acceptance or rejection of the appointment offer from the user device of the first user; and
receiving a meeting invitation at the user device of the first user if the first user and second user have accepted the appointment offer.

14. The method of claim 13, further comprising sending, from the user device of the first user, information indicating the predetermined distance for use in determining whether to suggest a meeting between the first user and another user.

15. The method of claim 13, further comprising sending, from the user device of the first user, information indicating time of day preference based on social distance in a social network of which the first user is a member.

16. The method of claim 13, further comprising inserting information about the meeting into a calendar application running on the user device of the first user.

17. The method of claim 13, further comprising at a user device of the second user, sending acceptance or rejection of the appointment offer.

18. The method of claim 17, further comprising receiving the meeting invitation at the user device of the second user if the second user if the first user and the second user have accepted the appointment offer.
